(19) United States
(12) Patent Application Publication
(10) Pub. No.: US 2018/0307676 A1
(43) Pub. Date: Oct. 25, 2018

(54) Systems, Devices, Components and Associated Computer Executable Code for Recognizing and Analyzing/Processing Modification Sentences within Human Language

(71) Applicant: NANOREP TECHNOLOGIES LTD., Herzliya Pituah, IL (US)

(72) Inventor: Amit Ben Shahar, Petah Tikva (IL)

(21) Appl. No.: 15/490,941

(22) Filed: Apr. 19, 2017

(51) Int. Cl. G06F 17/27; G06F 17/21

(52) U.S. Cl. CPC G06F 17/2785; G06F 17/218; G06F 17/278; G06F 17/277

(57) ABSTRACT

The present invention includes systems, devices, components and associated computer executable code for recognizing and analyzing modification sentences within human language. According to some embodiments, received natural language statements relating to previous statements are automatically identified and the original statements are then automatically modified/transformed based on processing logic designed to identify a type of transformation for each entity in the new statement.

### FIELD OF THE INVENTION

The present invention generally relates to the field of natural language processing. More specifically, the present invention relates to systems, devices, components and associated computer executable code for recognizing and analyzing modification sentences within human language.

### BACKGROUND

Modern times have found the computer and computerized systems to facilitate and manage a large majority of human activity. In modern society, the average person uses a computer to do anything from booking a flight to purchasing and reading a book to seeking out a psychologist, and so on. The average person, however, knows little to nothing about the operation of the computer he/she is using and relies on human-machine interfaces to facilitate communication of his/her instructions to the computer.

Designing these interfaces to accurately interpret intentions of many different people efficiently, while providing natural interfaces for these people that are easy to learn and use, is an important challenge on the way to fully integrating computers into our lives. One of the major difficulties encountered when trying to facilitate human-machine interaction is the dissonance between the dynamic and associative nature of human use of language as opposed to the formal and rigidly structured nature of computer languages. Whereas computer languages are governed by strict rules and syntax, human language is not.

It is therefore necessary to “teach” computers to “understand” human language. This requires not only teaching the computer the many possible meanings of each word, the many possible sentence structures possible in human language and how to identify and interpret each, but also the associative and contextual references in human language.

### SUMMARY OF THE INVENTION

The present invention includes systems, devices, components and associated computer executable code for augmenting natural human language processing systems and providing these systems with recognition and processing of sentences within human language that are modifications of previous sentences (hereinafter referred to as “modification sentences”) and not standalone sentences of themselves. The present invention includes systems, devices, components and associated computer executable code for: (1) recognizing modification sentences, and (2) computationally transforming previous sentences, based on the modification sentences, to produce transformed sentences, representing the intention of the modification sentences. The systems, devices, components and associated computer executable code of the present invention may be integrated into natural language processing systems and/or may be provided as separate components configured to externally augment natural language processing systems. According to yet further embodiments, portions of the systems described herein may be integrated into natural language processing systems and other portions kept separate. For example, modification sentence recognition components may be integrated into natural language processing systems while computational sentence transformation components are kept separate, such that the natural language processing systems recognize the modification sentences within natural language and send them to an exterior component for analysis/transformation.

Within human use of language, a sentence may be related to a previous sentence in the same conversation and further, may refer to information contained in the previous related sentence. For example, a user may inquire: “What time is there a train from Houston to Miami on December 3^{rd}?” and then proceed to inquire: “How about December 4^{th}?”. The second query is related to the first query and refers to the travel query contained in the first query, i.e. “time of a train from Houston to Miami”. Similarly, a user may query a computerized system “what time is there a train from Houston to Miami on December 3^{rd}?” and then proceed to inquire “non-stop please” or “how about a different day?”. Again, the second queries are related to the first query and refer to the travel query contained in the first query, i.e. “time of a train from Houston to Miami”, however, whereas in the first example the second query is a modification of the first query, in the second example the second query is a reduction of the first query and in the third a negation. For a human listener this is clear and easy to recognize. For a computer, this use of human language is an enigma. The present invention presents systems, methods and code for computationally resolving these types of enigmas using digital processing tools and logic.

According to some embodiments, there may be provided one or more processors for performing natural language processing of user queries/input/text, or one or more digital mediums containing computer executable code adapted to cause processors to perform the natural language processing, either including natural language processing logic. The natural language processors may be associated with any computerized system including a natural language input function, either integrally or as an augmentation.

According to some embodiments, natural language processing logic may include language processing logic for recognizing and analyzing modification sentences within natural human language and accordingly performing natural language processing. Recognizing modification sentences and associated processing may include:
a. receiving a new natural language statement;
b. detecting and analyzing entities within the new statement;
c. determining the new statement is a partial statement;
d. determining logical relations of entities within the new statement to an original/source (previous) statement, based on the class of each entity;
e. performing one or more transformations of the original statement based on the determined logical relations between the entities in the new statement and the original statement;
f. determining if any of the transformed entities are ‘unrelated’ to a current ‘intent’;
g. in the event that new classes were added to the new statement during the transformation, and/or if ‘unrelated’ entities were transformed, performing an intent detection of the transformed statement to determine if conversation intent should be repeated or modified; and
h. verifying all the transformed entities in the transformed statement are related to a current ‘intent’ of the transformed statement.

### BRIEF DESCRIPTION OF THE FIGURES

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram of an exemplary system for natural language processing, including logic for recognizing and analyzing modification sentences within human language, according to some embodiments of the present invention;

FIG. 2 is a flowchart showing steps of operation of an exemplary computerized recognition and analyses of modification sentences within human language, according to some embodiments of the present invention;

FIG. 3 is a flowchart showing steps of transformation of an exemplary natural language statement related to a previous natural language statement, all according to some embodiments of the present invention;

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, “automatically analyzing” or the like, refer to the action and/or processes of a computer, processing circuits of different forms and/or computing systems, or similar electronic computing devices, that manipulate and/or transform data represented as physical, such as electronic, quantities within the computing system's registers and/or memories into other data similarly represented as physical quantities within the computing system's memories, registers or other such information storage, transmission or display devices.

Accordingly, any descriptions herein referring to data processing and automated computerized processes should be understood to inherently include processors and/or processor executable code/logic for the execution of the described processes.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description herein. In addition, embodiments of the present invention are not described with reference to any particular programming language. It will be appreciated that a variety of programming languages may be used to implement the teachings of the inventions as described herein.

The present invention includes systems, devices, components and associated computer executable code for augmenting natural human language processing systems and providing these systems with recognition and processing of sentences within human language that are modifications of previous sentences (hereinafter referred to as “modification sentences”) and not standalone sentences of themselves. The present invention includes systems, devices, components and associated computer executable code for: (1) recognizing modification sentences, and (2) computationally transforming previous sentences, based on the modification sentences, to produce transformed sentences, representing the intention of the modification sentences. The systems, devices, components and associated computer executable code of the present invention may be integrated into natural language processing systems and/or may be provided as separate components configured to externally augment natural language processing systems. According to yet further embodiments, portions of the systems described herein may be integrated into natural language processing systems and other portions kept separate. For example, modification sentence recognition components may be integrated into natural language processing systems while computational sentence transformation components are kept separate, such that the natural language processing systems recognize the modification sentences within natural language and send them to an exterior component for analysis/transformation.

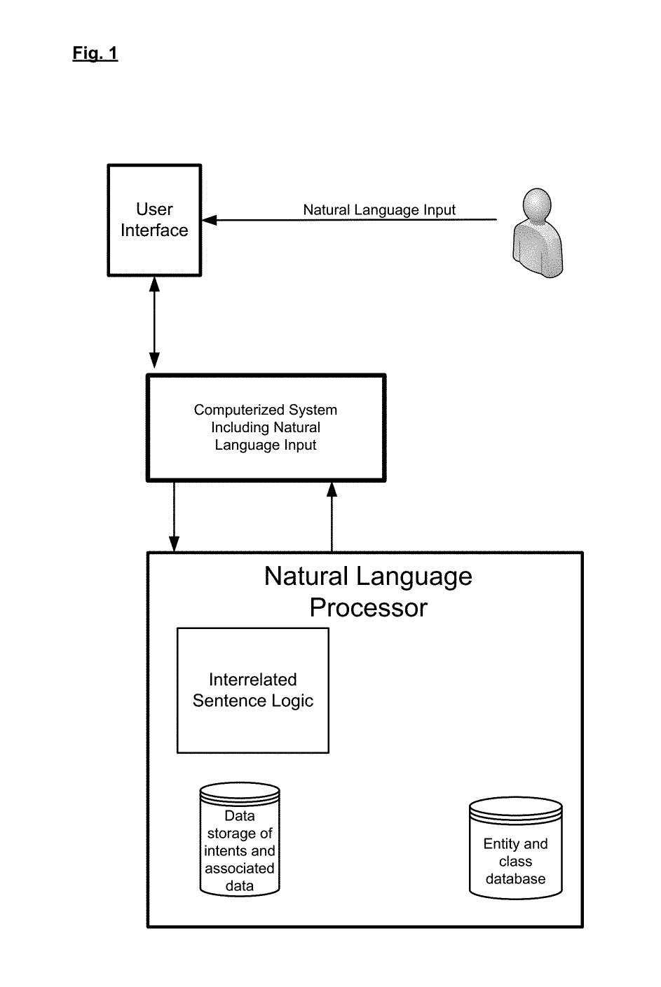

An exemplary system for performing natural language processing, including recognizing and analyzing modification sentences within human language, is presented in FIG. 1.

As shown in FIG. 1, which is a block diagram of an exemplary system for natural language processing including logic for recognizing and analyzing modification sentences within human language, according to some embodiments of the present invention, there may be provided one or more processors for performing natural language processing of user queries/input/text, or one or more digital mediums containing computer executable code adapted to cause processors to perform the natural language processing, either including natural language processing logic. The natural language processors may be associated with any computerized system including a natural language input function, either integrally or as an augmentation.

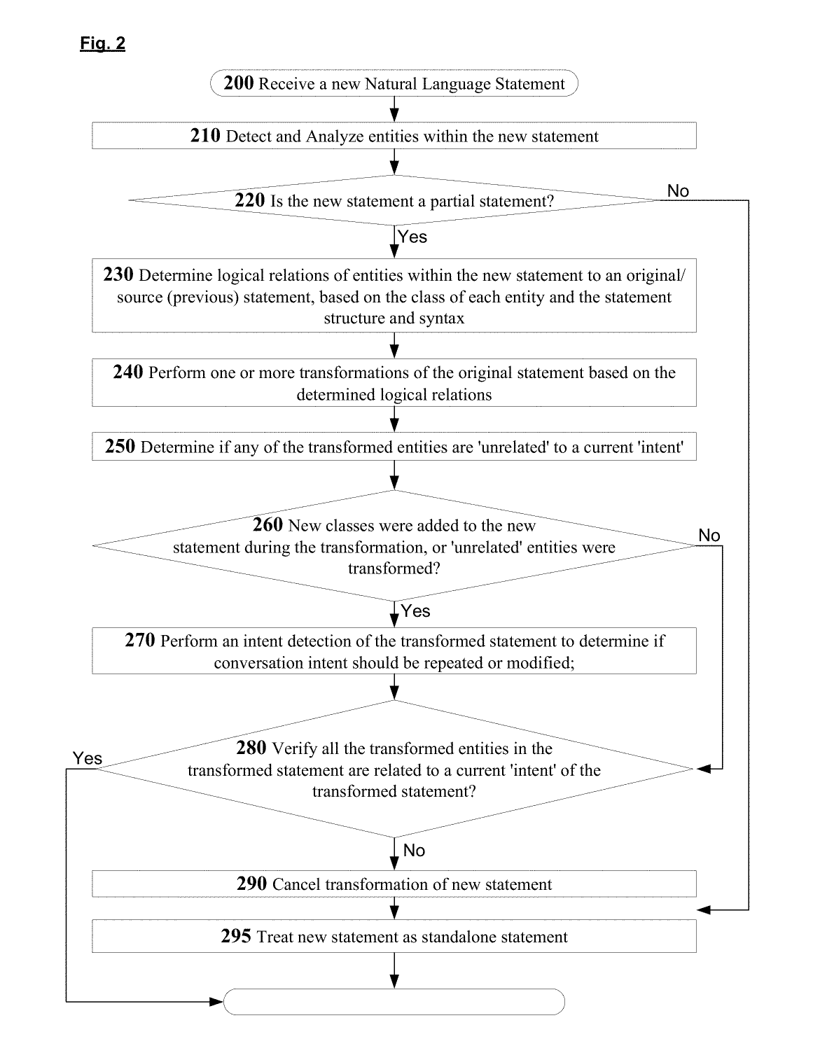

Reference is now made to FIG. 2, which is a flowchart showing steps of operation of an exemplary computerized recognition and analyses of modification sentences within human language, according to some embodiments of the present invention. According to some embodiments, natural language processing logic may include language processing logic for recognizing and analyzing modification sentences within natural human language and accordingly, performing natural language processing. Recognizing modification sentences and associated processing may include:
a. receiving a new natural language statement (200);
b. detecting and analyzing entities within the new statement (210);
c. determining the new statement is a partial statement (220);
d. determining logical relations of entities within the new statement to an original/source (previous) statement, based on the class of each entity and the statement structure and syntax (230);
e. performing one or more transformations of the original statement based on the determined logical relations between the entities in the new statement and the original statement (240);
f. determining if any of the transformed entities are ‘unrelated’ to a current ‘intent’ (250);
g. in the event that new classes were added to the new statement during the transformation, and/or if ‘unrelated’ entities were transformed (260), performing an intent detection of the transformed statement to determine if conversation intent should be repeated or modified (270); and
h. verifying all the transformed entities in the transformed statement are related to a current ‘intent’ of the transformed statement (280).

According to some embodiments, analyzing a natural language statement may include entity recognition. Analyzing natural language statements may further include identifying a class of each entity, a class of a class of each entity (2nd tier) and so on. For example, in the sentence “I would like to book a flight to London today”, the entity “London” is of the class ‘city’, which is a 2^{nd} tier class of the class ‘location’, and the entity “today” is of the class ‘date’. Detection of entities may be comprised of matching of sequences of tokens in the statement and their NL properties such as: (i) Parts-of-speech, (ii) syntax structure and (iii) position in the statement and relation to other tokens or entities in the statement.

Entity recognition may also be based on an entity graph (a graph data structure in which entities are represented as nodes and edges, where each node is an entity or a property of an entity and edges represent the relation between said nodes and entities). The entity graph may be indexed for text-based retrieval (by detected names or properties of the nodes) or for data-based retrieval (such as in cases of defined properties like date/time, geo location, weight, size, etc.).

The graph can also be traversed in order to disambiguate multiple possible entities for the same tokens by prioritizing closer linked entities, or disqualifying candidate entities that are not connected by any property to other matching entities.

Further, entity detection may be subject to pre-indexed entity assignment to parts of a known intent, such as ‘book a flight to paris’, the word ‘paris’ may be already indexed as a ‘LOCATION’ entity, and as such when processing new intents a ‘LOCATION’ entity will be prioritized when said intent has been detected, and other non related entities may be disqualified from being detected if the intent does not include them in the pre-indexed information (this may also support disambiguation of entity detection)

According to some embodiments, entity recognition and classification may be followed by an attempt for intent determination (e.g. ‘book flight’) by matching the statement to known intents stored in an associated repository.

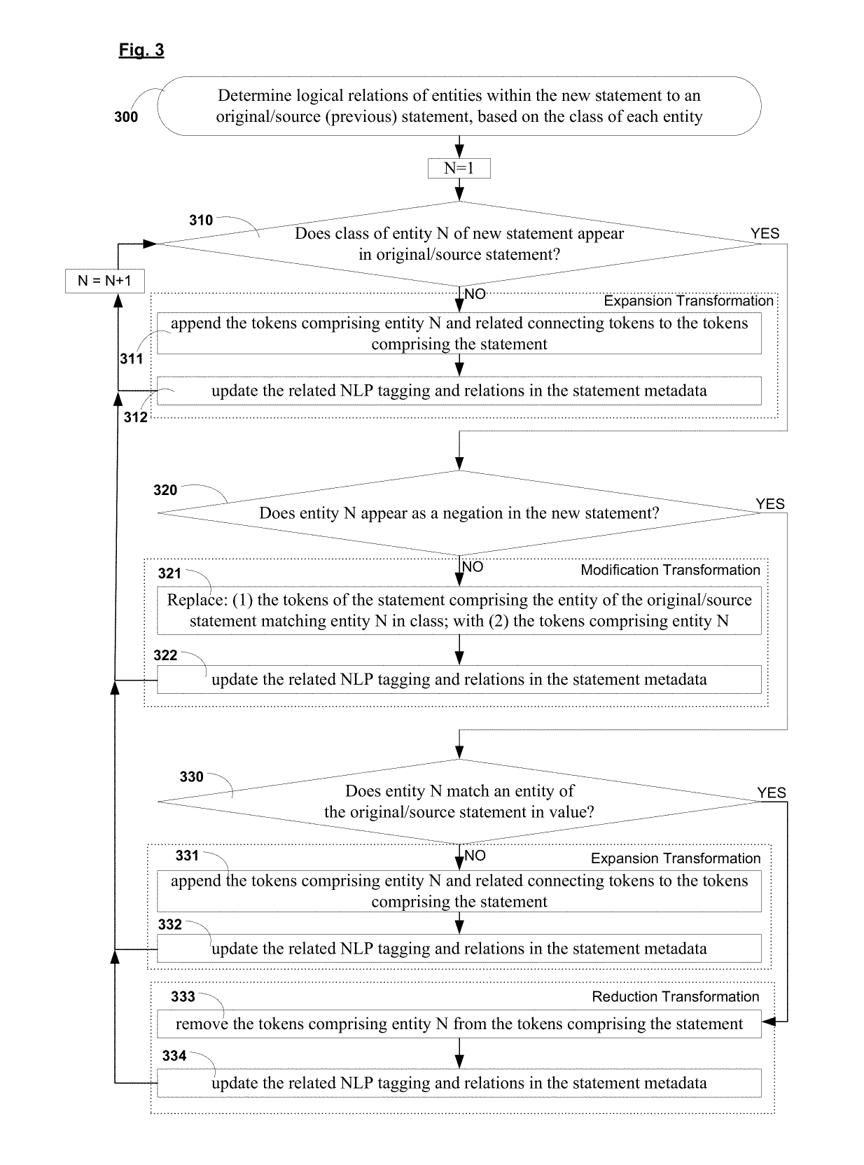

Reference is now made to FIG. 3. According to some embodiments, when a statement is received that may be a related statement, an initial analysis may be performed to determine if the statement is a partial statement. A partial statement may be defined as a statement in which all tokens of significance (i.e. informative tokens—not pleasantries, parts of syntax and so on) are related to the intent of a previous statement. The presence of an entity unrelated to the intent of a previous statement indicates this is a new standalone statement and not a partial statement.

Once it is determined that the statement is a partial statement, entities in the new statement are logically related to the previous/first statement based on their class (300) as either:
a. entities of a class which also appears in the previous/first statement (310);
b. entities of a class which also appears in the previous/first statement, however, being used as a negation in the second/partial statement (320). In this case, two logical relations are possible (330):
   i. entities in the second statement matching an entity in the first statement both in class and in value; and
   ii. entities in the second statement matching an entity in the first statement in class and not in value.
c. entities of a class which does not appear in the previous/first statement.

According to some embodiments, a first natural language statement may be adjusted/transformed based on a second modification natural language statement by performing a transformation of the first statement for each of one or more entities in the second statement. The transformation performed for each given entity in the second statement may be based on a logical relation of the given entity to the first statement:
a. entities of a class which also appears in the first statement

In this case a ‘modification’ transformation (321+322) may be required. The entity of matching class in the second statement is assumed to be intended to replace the entity of the same class in the first statement. An example may be a modification of a date in the previous statement or a modification of a location.

For example, a first statement may be “I would like to purchase a ticket to fly to London on January 29^{th}”. The second statement may be “make that January 30^{th}” or “sorry, Frankfurt”. ‘January 30^{th}’ is an entity of the class ‘date’, which also appears in the first statement ‘January 29^{th}’. Therefore, a modification transformation should be performed for this entity. Similarly, ‘Frankfurt’ is an entity of the class ‘location’, which also appears in the first statement ‘London’. Therefore, a modification transformation should be performed for this entity as well.
b (i). entities of a class which also appears in the previous/first statement, however, being used as a negation in the second/partial statement, matching an entity in the first statement both in class and in value:

In this case a ‘reduction’ transformation may be required (333+334). The entity of matching class in the second statement, matching both in class and in value yet appearing the negative, is assumed to be intended to reduce the first statement to not include the first entity.

For example, a first statement may be “I would like to purchase a ticket to fly to London on January 29^{th} in the morning”. The second statement may be “sorry, not in the morning”. ‘morning’ is an entity of the class ‘time of day’, which also appears in the first statement in the same value. Therefore, a reduction transformation should be performed for this entity.
b (ii). entities of a class which also appears in the previous/first statement, however, being used as a negation in the second/partial statement, matching an entity in the first statement in class but not in value:

In this case an ‘expansion’ transformation may be required (331+332). The entity of matching class in the second statement, matching in class yet not in value and appearing the negative, is assumed to be intended to expand the first statement to include the negative information.

For example, a first statement may be “I would like to purchase a ticket to fly to London on January 29^{th} in the morning”. The second statement may be “sorry, not in the morning”. ‘morning’ is an entity of the class ‘time of day’, which also appears in the first statement in the same value. Therefore, a reduction transformation should be performed for this entity.
c. entities of a class which does not appear in the first statement

In this case an ‘expansion’ transformation may be required (311+312). The new entity in the second statement, of a class not appearing in the first statement, is assumed to be intended to expand the information provided in the first statement. An example may be an addition of a date in the previous statement or an addition of a location.

For example, a first statement may be “I would like to purchase a ticket to fly to London”. The second statement may be “January 30^{th}” or “non-stop please”. ‘January 30^{th}’ is an entity of the class ‘date’, which does not appear in the first statement ‘January 29^{th}’. Therefore, an expansion transformation should be performed for this entity. Similarly, ‘non-stop’ is an entity of the class ‘# of stops’, which also does not appear in the first statement. Therefore, an expansion transformation should be performed for this entity as well.

According to some embodiments, transformation of a first statement may include processing of multiple entities detected in the second statement.

According to some embodiments, a ‘modification’ transformation may include: (i) replacing the tokens comprising the matched entity in the first statement with tokens comprising the matched entity in the second statement and/or tokens connected to the matched entity which are required in order to maintain NL structure and tagging, and (ii) updating the related NLP tagging and relations in the statement metadata. Tokens connected to the matched entity are tokens used in the language to sustain the NLP roles of the tokens and entities such as “from”/“to”. Thus, in the partial statement “and from new York” the token “from” will also be appended even though it is not part of the entity.

According to some embodiments, a ‘reduction’ transformation may include: (i) removing the tokens comprising the matched entity in the first statement, and (ii) updating the related NLP tagging and relations in the statement metadata.

According to some embodiments, an ‘expansion’ transformation may include: (i) appending the tokens comprising the matched entity in the second statement to the tokens comprising the first statement, and (ii) updating the related NLP tagging and relations in the statement metadata.

According to some embodiments, after transformation, a check may be performed to determine if any of the transformed entities are ‘unrelated’ to a current ‘intent’. An entity class is ‘related’ to a given ‘intent’ if it is included in the intent training data or metadata, or manually added to the intent metadata.

According to some embodiments, in the event that new classes were added to the statement during the transformation, and/or if ‘unrelated’ entities were transformed, an intent detection may be performed upon the transformed statement to determine if the current conversation intent should be repeated or modified.

According to some embodiments, if a transformation of any of the entities in the second statement produces an entity unrelated to the detected intent of the transformed statement, an attempt to find a different intent matching the transformed statement structure and components, and related to all transformed entities, should be performed. If this also fails, the transformation should not be performed (290 in FIG. 2) and the second statement should be treated as a standalone statement (295 in FIG. 2).

Entity detection may also be performed through other techniques that aim to characterize tokens based on meaning, such as, but not limited to, word vectorization and classification (e.g. word2vec), in which entity matching is performed by checking for similarity between vectors within a defined threshold.

An exemplary use of the above described processes may also be implemented within a computer-user dialog, such the computer queries the user for further information regarding a query, receives a response from the user which is related to previous input from the user (e.g. the query) and uses the above described methods to adjust the query accordingly, possibly further as an iterative process. For example: When a conversation flow queries the user for additional information to handle an intent (user: “book a flight”, bot: “where to?”), the user response with the missing information can be handled by detecting that the new statement adds information to the previous statement, effectively transforming it and then processing the newly transformed statement.

The present invention can be practiced by employing conventional tools, methodology and components. Accordingly, the details of such tools, component and methodology are not set forth herein in detail. In the previous descriptions, numerous specific details are set forth, in order to provide a thorough understanding of the present invention. However, it should be recognized that the present invention might be practiced without resorting to the details specifically set forth.

In the description and claims of embodiments of the present invention, each of the words, “comprise” “include” and “have”, and forms thereof, are not necessarily limited to members in a list with which the words may be associated.

Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A system for recognizing modification sentences within natural human language, said system comprising:
a database containing records of classes of human language entities;
a computing platform including processing circuitry communicatively coupled to said database and adapted to:
(a) receive digital data representing a first set of language entities comprising a first sentence of human language;
(b) determine first classes of the first set of language entities;
(c) receive digital data representing a second set of language entities comprising a second sentence of human language;
(d) determine second classes of the second set of language entities;
(e) recognize the second sentence as a partial sentence intended to modify the content of the first sentence;
(f) computationally transform the first sentence to a transformed sentence having the meaning intended by the second sentence, by performing transformations of the first sentence based on logical relations between the second classes and the first classes.

2. The system according to claim 1, wherein said processing circuitry is further configured to computationally detect an intent of the transformed sentence.

3. The system according to claim 2, further wherein said processing circuitry is further configured to verify transformed entities are related to the detected intent.

4. The system according to claim 1, wherein computationally transforming includes appending tokens comprising a given entity of the second set of entities.

5. The system according to claim 4, wherein computationally transforming based on logical relations between the second classes and the first classes includes identifying entities of the second set which are of a class not appearing in the first set, and
accordingly appending to the tokens of the first set, tokens comprising the identified entities.

6. The system according to claim 1, wherein computationally transforming includes updating natural language processing tagging relating to the given entity.

7. The system according claim 1, wherein computationally transforming includes replacing within the tokens comprising the first set: (i) first tokens comprising a first given entity of the first set of entities, with (ii) second tokens comprising a second given entity of the second set of entities.

8. The system according to claim 7, wherein computationally transforming based on logical relations between the second classes and the first classes includes identifying the second given entity and the first given entity are of the same class and,
accordingly replacing the first tokens with the second tokens.

9. The system according to claim 1, wherein computationally transforming includes removing from the tokens comprising the first set, tokens comprising a given entity of the second set of entities.

10. The system according to claim 9, wherein computationally transforming based on logical relations between the second classes and the first classes includes identifying entities of the second set which appear as a negation in the second sentence and are identical in class and value to an entity in the first set, and accordingly removing from the tokens of the first set, tokens comprising the identified entities.

11. A system for recognizing logically interrelated sentences within natural human language, said system comprising:
a tangible medium containing computer executable code configured to cause a computing platform to:
(a) receive digital data representing a first set of language entities comprising a first sentence of human language;
(b) determine first classes of the first set of language entities;
(c) receive digital data representing a second set of language entities comprising a second sentence of human language;
(d) determine second classes of the second set of language entities;
(e) recognize the second sentence as a partial sentence intended to modify the content of the first sentence;
(f) computationally transform the first sentence to a transformed sentence having the meaning intended by the second sentence, by performing transformations of the first sentence based on logical relations between the second classes and the first classes.

12. A method for recognizing logically interrelated sentences within natural human language, said method comprising:
receiving digital data representing a first set of language entities comprising a first sentence of human language;
determining first classes of the first set of language entities;
receiving digital data representing a second set of language entities comprising a second sentence of human language;
determining second classes of the second set of language entities;
recognizing the second sentence as a partial sentence intended to modify the content of the first sentence;
computationally transforming the first sentence to a transformed sentence having the meaning intended by the second sentence, by performing transformations of the first sentence based on logical relations between the second classes and the first classes.

13. The method according to claim 12, further comprising computationally detecting an intent of the transformed sentence and verifying transformed entities are related to the detected intent.

14. The method according to claim 12, wherein said computationally transforming includes appending tokens comprising a given entity of the second set of entities.

15. The method according to claim 14, wherein said computationally transforming based on logical relations between the second classes and the first classes includes identifying entities of the second set which are of a class not appearing in the first set, and
accordingly appending to the tokens of the first set, tokens comprising the identified entities.

16. The method according to claim 12, wherein said computationally transforming includes updating natural language processing tagging relating to the given entity.

17. The method according claim 12, wherein said computationally transforming includes replacing within the tokens comprising the first set: (i) first tokens comprising a first given entity of the first set of entities, with (ii) second tokens comprising a second given entity of the second set of entities.

18. The method according to claim 17, wherein said computationally transforming based on logical relations between the second classes and the first classes includes identifying the second given entity and the first given entity are of the same class and,
accordingly replacing the first tokens with the second tokens.

19. The method according to claim 12, wherein said computationally transforming includes removing from the tokens comprising the first set, tokens comprising a given entity of the second set of entities.

20. The method according to claim 19, wherein said computationally transforming based on logical relations between the second classes and the first classes includes identifying entities of the second set which appear as a negation in the second sentence and are identical in class and value to an entity in the first set, and
accordingly removing from the tokens of the first set, tokens comprising the identified entities.
